(19) United States
(12) Patent Application Publication
(10) Pub. No.: US 2010/0169980 A1
(43) Pub. Date: Jul. 1, 2010

(54) PERSONAL INFORMATION PROVIDING APPARATUS AND METHOD

(75) Inventors: Hwan Joon KIM, Seoul (KR); Weon Il JIN, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/545,816

(22) Filed: Aug. 22, 2009

(30) Foreign Application Priority Data
Dec. 29, 2008 (KR) 10-2008-0135164

(51) Int. Cl. G06F 21/24

(52) U.S. Cl. 726/27; 726/26

(57) ABSTRACT

A personal information providing method and apparatus is provided. The personal information providing apparatus may extract personal information about at least one characteristic corresponding to a predetermined standard from a database storing personal information of a plurality of characteristics, embed the personal information about the at least one characteristic in a predetermined image, generate a personal information image, generate a watermark having trace information embedded, and embed the watermark in the personal information image.

### CROSS-REFERENCE TO RELATED APPLICATION

This application claims the benefit under 35 U.S.C. §119(a) of a Korean Patent Application No. 10-2008-0135164, filed on Dec. 29, 2008, in the Korean Intellectual Property Office, the entire disclosure of which is incorporated herein by reference.

### BACKGROUND

1. Field

The following description relates to a personal information providing apparatus and method. More particularly, the description relates to a personal information providing apparatus and method allowing a user to select personal information based on a predetermined standard, provide the selected personal information to a requesting person, and trace a leakage path of personal information when the personal information is leaked.

2. Description of the Related Art

Various businesses, such as service providers, may use personal information of users during the course of their business. Accordingly, most service providers may at times make a request for personal information of users. However, it is common for users to be reluctant to provide their personal information to use a service of the service providers requesting the personal information.

In addition, some businesses have been held accountable for unauthorized access to personal information in their possession. For example, recently, a variety of damages related to personal information leaks have been reported.

Generally, personal information provided by users may be managed through a server of service providers. Accordingly, users typically do not manage their personal information by themselves, and when personal information is leaked, a path or source of the leak may not be easily traced.

Accordingly, there is a need for technologies which may enable a user to manage the user's personal information on his/her own and provide information to a person requesting personal information of the user only when desired by the user.

Also, there is a need for technologies which may enable a user to easily ascertain an information leakage path on his/her own, when personal information of the user is leaked.

Also, there is a need for technologies which may enable personal information to be managed and may enable a path of the unauthorized leak of information to be traced through a personal terminal.

### SUMMARY

In one general aspect, a personal information providing apparatus includes a database to store personal information of a plurality of characteristics; a personal information extraction unit to extract personal information about at least one characteristic corresponding to a predetermined standard from the database; an image generation unit to embed the personal information about the at least one characteristic in a predetermined image and generate a personal information image; a watermark generation unit to generate a watermark having trace information embedded therein, the trace information configured to trace the generation of the personal information image; and a merging unit to embed the watermark in the personal information image.

In another general aspect, a personal information providing method includes extracting personal information about at least one characteristic corresponding to a predetermined standard from a database storing personal information of a plurality of characteristics; embedding the personal information about the at least one characteristic in a predetermined image and generating a personal information image; generating a watermark having trace information embedded therein, the trace information configured to trace the generation of the personal information image; and embedding the watermark in the personal information image.

A personal information providing apparatus and method may generate an image associated with personal information where a type or a level of access to the personal information are determined according to a personal information management policy, may embed a trace information-embedded watermark in the image, and thereby may easily manage the personal information and ascertain a path of any unauthorized leak of the personal information.

Other features will be apparent from the following detailed description, the drawings, and the claims.

### BRIEF DESCRIPTION OF THE DRAWINGS

FIG. 1 is a block diagram illustrating an exemplary configuration of a personal information providing apparatus.

FIG. 2 is a conceptual diagram illustrating an example of an operation of an image generation unit.

FIG. 3 is a conceptual diagram illustrating an example of an operation of a random code generation unit.

FIG. 4 is a conceptual diagram illustrating an example of an operation of a watermark generation unit.

FIG. 5 is a conceptual diagram illustrating an example of an operation of a personal information requesting terminal.

FIG. 6 is a flowchart illustrating an exemplary personal information providing method.

Throughout the drawings and the detailed description, unless otherwise described, the same drawing reference numerals refer to the same elements, features, and structures. The relative size and depiction of these elements may be exaggerated for clarity and convenience.

### DETAILED DESCRIPTION OF EMBODIMENTS

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, descriptions of well-known functions and constructions may be omitted for increased clarity and conciseness.

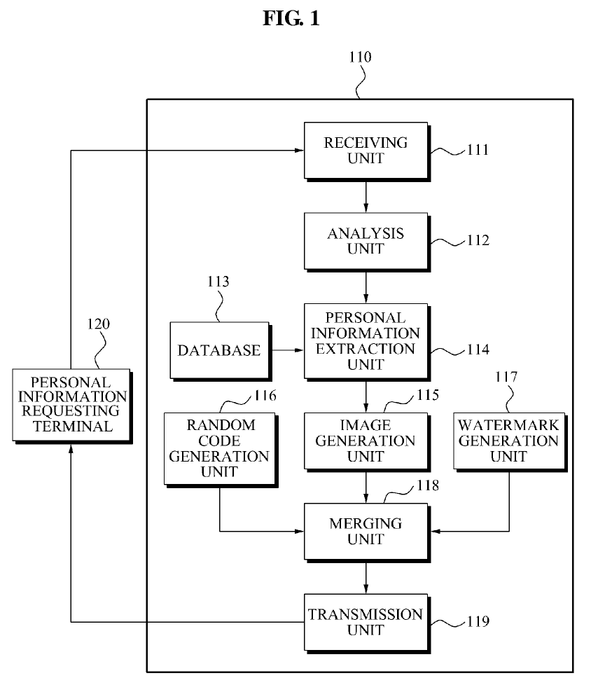

FIG. 1 illustrates a configuration of an exemplary personal information providing apparatus 110. Referring to FIG. 1, the personal information providing apparatus 110 and a personal information requesting terminal 120 are illustrated.

The personal information providing apparatus 110 may include a database 113, a personal information extraction unit 114, an image generation unit 115, a watermark generation unit 117, and a merging unit 118.

Personal information of a plurality of characteristics of the user may be stored in the database 113. In one example, the personal information of the plurality of characteristics may be configured in a predetermined code and stored in the database 113.

The personal information extraction unit 114 may extract personal information about at least one characteristic corresponding to a predetermined standard from the database 113.

The personal information providing apparatus 110 may further include a receiving unit 111 and an analysis unit 112. The receiving unit 111 may receive a personal information request from the personal information requesting terminal 120. For example, the personal information requesting terminal 120 may be used when a manager of a store, such as a beauty salon, a restaurant, and the like sends the personal information request to the personal information providing apparatus 110 to collect personal information of a customer.

The analysis unit 112 may analyze the personal information request and determine the predetermined standard. The predetermined standard may include at least one of a type, a level of access, and the like with respect to the personal information.

For example, when a manager of a beauty salon transmits the personal information request through the personal information requesting terminal 120, the analysis unit 112 may analyze the personal information request and determine the type or the level of access to the personal information that is to be provided to the manager according to a predetermined personal information policy.

When the personal information policy only allows access to personal information about an age, a sex, and a favorite hairstyle, from among the personal information about at least one characteristic, to be provided with respect to a beauty salon, the analysis unit 112 may analyze the personal information request and determine the predetermined standard to enable only the personal information about the age, the sex, and the favorite hairstyle to be provided to the personal information requesting terminal 120.

In this instance, the personal information extraction unit 114 may extract only the personal information about the age, the sex, and the favorite hairstyle from the database 113 based on the determined standard.

The personal information extraction unit 114 may extract the personal information about the at least one characteristic based on the level of access to of personal information corresponding to the determined standard.

For example, when only the personal information about the age, the sex, and the favorite hairstyle may be provided to the personal information requesting terminal 120, and access is further limited to provide only an age group, as opposed to a particular age, according to the level of access to the personal information, the personal information extraction unit 114 may extract personal information only about an age bracket from the database 113.

The image generation unit 115 may embed the extracted personal information about the at least one characteristic in a predetermined image and generate a personal information image. The image generation unit 115 also may apply an access control factor to the personal information about the at least one characteristic to generate the personal information image. The access control factor may be determined based on the level of access to the personal information.

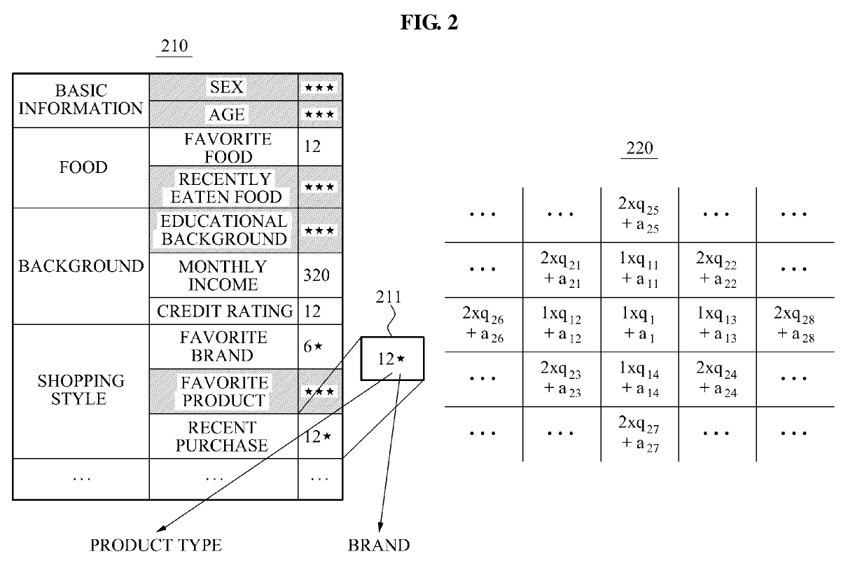

An operation of the image generation unit 115 is described in detail with reference to FIG. 2. FIG. 2 conceptually illustrates an example of an operation of the image generation unit 115.

As illustrated in table 210 of FIG. 2, the personal information extraction unit 114 may extract personal information about at least one characteristic corresponding to a predetermined standard from the database 113.

For example, the personal information about a “favorite food,” a “monthly income,” a “credit rating,” a “favorite brand,” and a “recent purchase” is extracted from among the personal information about the at least one characteristic in the table 210 by the personal information extraction unit 114.

Also, the personal information about the at least one characteristic may be configured in a predetermined code and stored in the database 113 as illustrated in table 210 of FIG. 2.

For example, table 210 illustrates that the personal information about the recent “purchase” is configured in a predetermined code in cell 211 of table 210 in FIG. 2. In this example, the cell 211 includes the code including a “1” and a “2.” The “1” may indicate information about a product type, and the “2” may indicate information about a brand.

Also, the personal information extraction unit 114 may extract the personal information about the at least one characteristic based on a level of access to the personal information corresponding to the predetermined standard as illustrated in table 210 of FIG. 2.

For example, table 210 illustrates that the personal information may include the “favorite brand” and the “recent purchase.” This information may be of “limited access” in table 210 of FIG. 2 as an example.

When the personal information extraction unit 114 extracts the personal information about the at least one characteristic corresponding to the predetermined standard from the database 113 as illustrated in table 210 of FIG. 2, the image generation unit 115 may embed the personal information about the at least one characteristic in a predetermined image and generate a personal information image.

An example of generating the personal information image of the image generation unit 115 is illustrated in table 220 of FIG. 2.

The image generation unit 115 may convert the extracted personal information about the at least one characteristic into a predetermined pixel value to be embedded in each of at least one pixel of the personal information image. In this instance, the at least one pixel may construct a predetermined image. Of course, an image may include multiple pixels.

Subsequently, the image generation unit 115 may embed the converted pixel value in each of the at least one pixel as illustrated in table 220 of FIG. 2.

In this instance, the image generation unit 115 may apply a access control factor to the personal information about the at least one characteristic to generate the personal information image. The access control factor may be determined based on the level of access to the personal information.

This example illustrates that “qᵢⱼ” and “aₖₗ” are used as the access control factor in table 220 of FIG. 2. Here, qᵢⱼ may indicate a quantization coefficient and aₖₗ may indicate a noise factor. That is, the image generation unit 115 may change qᵢⱼ and aₖₗ depending on the level of access to the personal information, and thereby control the predetermined pixel value that is to be embedded in each of the at least one pixel.

Here, as qᵢⱼ increases, the level of access to the personal information may increase. Also, as aₖₗ increases, the level of access to the personal information may decrease.

Specifically, the personal information requesting terminal 120 may generate a second personal information image based on the personal information about the at least one characteristic stored in the personal information requesting terminal 120. Also, the personal information requesting terminal 120 may calculate a correlation between the second personal information image and the personal information image received from the personal information providing apparatus 110. Accordingly, the personal information requesting terminal 120 may estimate personal information of a user of the personal information providing apparatus 110.

That is, as qᵢⱼ increases, the correlation between the second personal information image and the personal information image may increase, and as aₖₗ increases, the correlation between the second personal information image and the personal information image may decrease. Accordingly, the level of access to the personal information may be determined depending on qᵢⱼ and aₖₗ.

An operation of the personal information requesting terminal 120 is further described in detail below.

The operation of the image generation unit 115 has been described above with reference to FIG. 2. Hereinafter, the personal information providing apparatus 110 is further described with reference to FIG. 1.

The personal information providing apparatus 110 also may further include a random code generation unit 116 and the merging unit 118. The random code generation unit 116 may generate at least one Pseudo Random Noise (PN) code. The merging unit 118 may embed the at least one PN code in the personal information image.

Accordingly, the personal information providing apparatus 110 may change the predetermined pixel value, included in the personal information image, through the random code generation unit 116, and thereby may control the level of access to the personal information

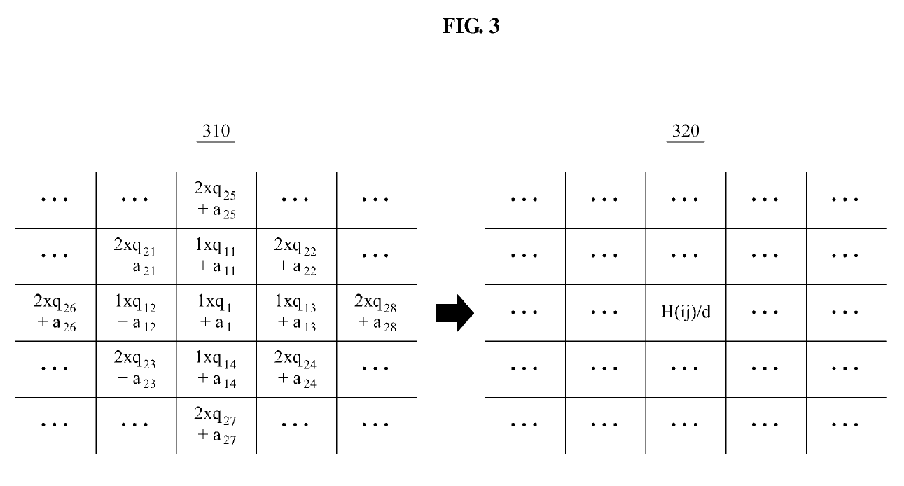

An operation of the random code generation unit 116 is described in detail with reference to FIG. 3. FIG. 3 conceptually illustrates an example of an operation of the random code generation unit 116.

When the image generation unit 115 generates a personal information image by embedding a predetermined pixel value in each of at least one pixel as illustrated in table 310 of FIG. 3, the random code generation unit 116 may apply a secure hash function to the predetermined pixel value embedded in each of the at least one pixel, and generate PN code with respect to each of the at least one pixel.

It is illustrated that the random code generation unit 116 generates the PN code with respect to each of the at least one pixel in table 320 of FIG. 3.

Here, a user may control an influence of the PN code on the predetermined pixel value embedded in each of the at least one pixel by adjusting a value “d,” which divides a value of the secure hash function.

When the random code generation unit 116 generates the at least one PN code as illustrated in table 320 of FIG. 3, the merging unit 118 may embed the at least one PN code in the personal information image.

Referring back to FIG. 1, the watermark generation unit 117 may generate a watermark having trace information embedded therein. The trace information may be used for tracing the personal information image. For example, the merging unit 118 may embed the watermark in the personal information image.

The trace information may include information about a generation time of the personal information image, a transmission time of the personal information image, and the personal information requesting terminal 120.

By providing trace information, when the personal information image generated by the personal information providing apparatus 110 is illicitly leaked or provided in an unauthorized manner, the user may trace a leakage path or trail of the unauthorized use of the personal information image through the watermark embedded in the personal information image.

That is, the user may extract the trace information embedded in the watermark through a secret key, and the like, and thereby may ascertain information about the generation time of the personal information image, the transmission time of the personal information image, and/or the personal information requesting terminal 120 that requested the information. In this instance, only the user may know the secret key, and the like. Accordingly, the path of a leak or trail of the unauthorized use of the personal information image may be traced.

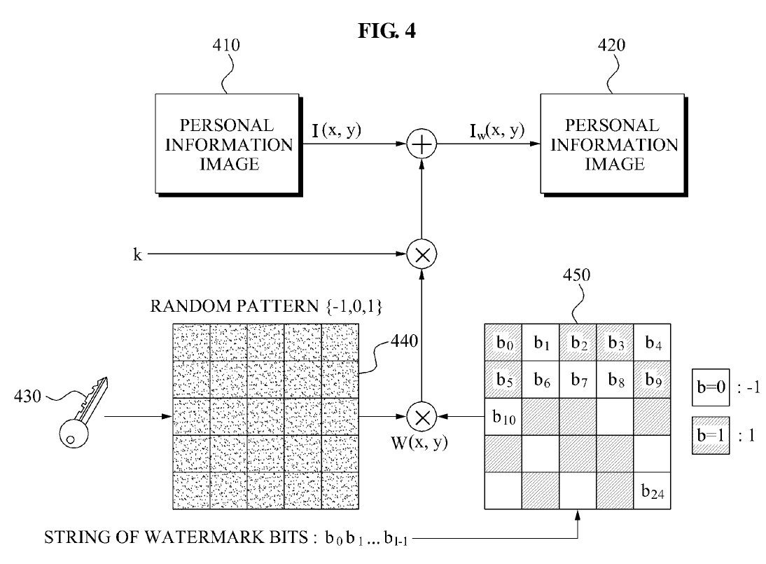

An operation of the watermark generation unit 117 is described in detail with reference to FIG. 4. FIG. 4 conceptually illustrates an example of an operation of the watermark generation unit 117.

The watermark generation unit 117 may generate a basic watermark 440 appropriate for a characteristic of the personal information image from a secret key 430. The secret key 430 may be used for subsequent watermark extraction.

The watermark generation unit 117 may generate a string 450 of watermark bits and embed the string 450 in the basic watermark 440. The string 450 of watermark bits may include the trace information.

As an example, the trace information may include information about a generation time of the personal information image, a transmission time of the personal information image, and/or the personal information requesting terminal 120.

The merging unit 118 may embed the basic watermark 440 having the string 450 of watermark bits embedded in a personal information image 410 by appropriately adjusting a watermark embedding strength k.

When a watermark-embedded personal information image 420 is illicitly leaked, a user may extract the basic watermark 440 from the watermark-embedded personal information image 420 using the secret key 430 and analyze the string 450 of watermark bits. Accordingly, a path of a leak of the watermark-embedded personal information image 420 may be traced.

Referring to FIG. 1, the personal information providing apparatus 110 may further include a transmission unit 119. The transmission unit 119 may transmit the personal information image to the personal information requesting terminal 120.

When the personal information image is received from the personal information providing apparatus 110, the personal information requesting terminal 120 may generate a second personal information image by referring to a table storing predetermined personal information. Also, the personal information requesting terminal 120 may calculate a correlation between the personal information image and the second personal information image. That is, the personal information requesting terminal 120 may compare the personal information image to the second personal information image, and thereby estimate personal information of the user of the personal information providing apparatus 110.

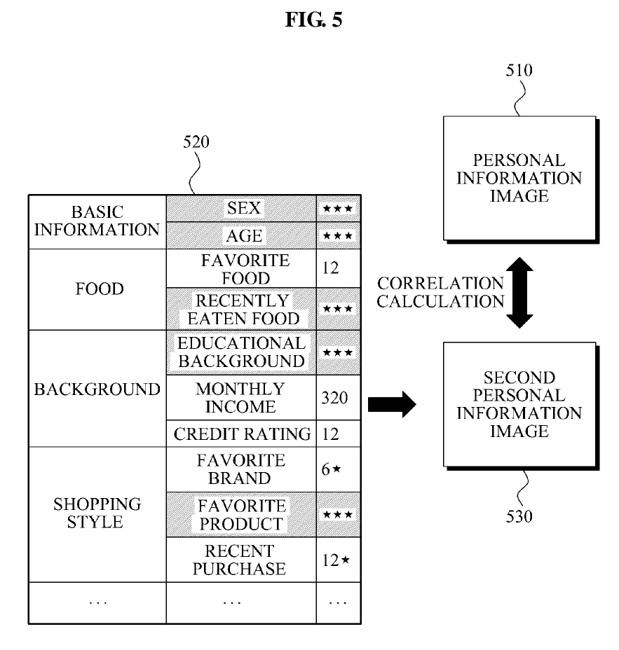

An operation of the personal information requesting terminal 120 is described in detail with reference to FIG. 5. FIG. 5 conceptually illustrates an example of an operation of the personal information requesting terminal 120.

The personal information requesting terminal 120 may include a table storing predetermined personal information as illustrated in table 520 of FIG. 5.

For example, when a user of the personal information requesting terminal 120 is a manager of a beauty salon, the manager may select personal information for management of the beauty salon, and store the selected personal information in the table 520.

The predetermined personal information may include a “favorite food,” a “monthly income,” “a credit rating,” a “favorite brand,” and a “recent purchase,” among others shown in FIG. 5, from among the personal information about the at least one characteristic stored in the table 520.

When a personal information image 510 is received from the personal information providing apparatus 110, the personal information requesting terminal 120 may generate a second personal information image 530 by referring to the table 520 storing the predetermined personal information.

In this instance, the second personal information image 530 may be generated by the personal information requesting terminal 120 in a same way that the personal information providing apparatus 110 generates the personal information image 510.

The personal information requesting terminal 120 may calculate a correlation between the personal information image 510 and the second personal information image 530. Using the correlation calculation, the user of the personal information requesting terminal 120 may ascertain a similarity between the personal information image 510 and the second personal information image 530.

Accordingly, the user of the personal information requesting terminal 120 may select a user of the personal information providing apparatus 110, which transmits personal information that the user of the personal information requesting terminal 120 requires, and may provide an appropriate service, and the like.

Although it is not illustrated in FIG. 1, the personal information providing apparatus 110 may further include a watermark extraction unit (not shown) and a trace information extraction unit (not shown).

As described above, the personal information providing apparatus 110 may embed the watermark, having the trace information embedded, in the personal information image. Accordingly, when personal information is illicitly leaked, the personal information providing apparatus 110 may enable the user to analyze the watermark embedded in the personal information image and to trace a source or a path of leak of the personal information image.

In this instance, the user may analyze the watermark from the personal information image using a separate analysis device or module, or using the personal information providing apparatus 110 itself.

The watermark extraction unit may extract the watermark, embedded in the personal information image, from the personal information image. The trace information extraction unit may extract the trace information from the extracted watermark.

For example, as a result of extracting the trace information by the trace information extraction unit, when it is determined that a generation time of the personal information image is Dec. 25, 2008, 1:00 pm, a transmission time of the personal information image is Dec. 25, 2008, 1:01 pm, and the personal information requesting terminal 120 receiving the personal information image is a terminal of a manager of a beauty salon, the user may determine that personal information of the user was illicitly leaked by the manager of the beauty salon.

Accordingly, the user may use the trace information as evidence, when a dispute associated with the leak or unauthorized access of the personal information occurs. That is, the user may trace the leakage path or the source of the leak of the personal information through a secret key that only the user knows using the personal information providing apparatus 110.

The personal information providing apparatus 110 may be included in or coupled with a variety of multimedia devices, such as a mobile communication terminal, a computer, a laptop, a personal digital assistant (PDA), a Moving Picture Experts Group (MPEG) Audio-Layer 3 (MP3) player, a portable media player (PMP), and the like.

In particular, when the personal information providing apparatus 110 is included in or coupled with a mobile device such as a mobile communication terminal, the personal information providing apparatus 110 may be used for a mobile advertising service based on personal information.

For example, a mobile advertising provider may receive a personal information image from the personal information providing apparatus 110, calculate a correlation between the personal information image and a second personal information image, and thereby may determine whether a user of the personal information providing apparatus 110 is a target for mobile advertising of the mobile advertising provider. In this instance, the second personal information image is generated by the mobile advertising provider. Accordingly, the mobile advertising provider may increase an efficiency of mobile advertising.

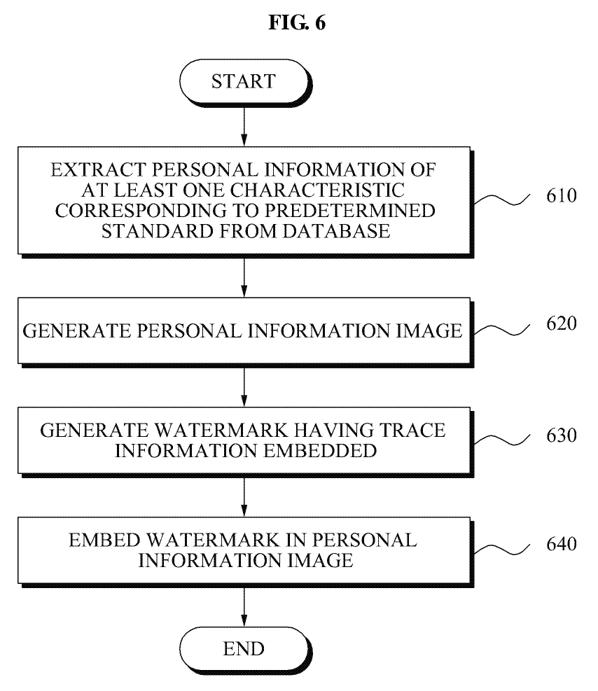

FIG. 6 illustrates an exemplary personal information providing method.

In operation 610, personal information about at least one characteristic corresponding to a predetermined standard may be extracted from a database storing personal information of a plurality of characteristics.

In this instance, the personal information providing method may further include an operation of receiving a personal information request from a personal information requesting terminal, and an operation of analyzing the personal information request and determining the predetermined standard prior to operation 610.

In operation of 620, the personal information about the at least one characteristic may be embedded in a predetermined image and a personal information image may be generated.

In this instance, the personal information about the at least one characteristic may be extracted based on a level of access to personal information corresponding to the predetermined standard in operation 610.

In this instance, an access control factor may be applied to the personal information about the at least one characteristic to generate the personal information image in operation 620. The access control factor may be determined based on the level of access to the personal information.

Also, the personal information providing method may further include an operation of generating at least one PN code and an operation of embedding the at least one PN code in the personal information image after operation 620.

In operation of 630, a watermark having trace information embedded may be generated. The trace information may be used for tracing the personal information image.

In operation 640, the watermark may be embedded in the personal information image.

In this instance, the personal information providing method may further include an operation of transmitting the personal information image to the personal information requesting terminal.

Also, when the personal information image is received, the personal information requesting terminal may generate a second personal information image by referring to a table storing predetermined personal information, and calculate a correlation between the personal information image and the second personal information image.

Using the calculated correlation, a user of the personal information requesting terminal may determine a similarity between the personal information image and the second personal information image.

The personal information providing method has been described above with reference to FIG. 6. Further detailed descriptions are omitted herein, since the personal information providing method may correspond to a configuration of the personal information providing apparatus described with reference to FIGS. 1 through 5.

The above-described methods may be recorded, or fixed in one or more computer-readable media that includes program instructions to be implemented by a computer to cause a processor to execute or perform the program instructions. The media may also include, independent or in combination with the program instructions, data files, data structures, and the like. Examples of computer-readable media may include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like Examples of program instructions include both machine code, such as produced by a compiler, and files containing higher level code that may be executed by the computer using an interpreter. The described hardware devices may be configured to act as one or more software modules or units in order to perform the methods and/or operations described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A personal information providing apparatus, comprising:
a database to store personal information of a plurality of characteristics;
a personal information extraction unit to extract personal information from the database regarding at least one characteristic corresponding to a predetermined standard;
an image generation unit to embed the extracted personal information about the at least one characteristic in a predetermined image and generate a personal information image;
a watermark generation unit to generate a watermark having trace information embedded therein, the trace information configured to trace generation of the personal information image; and
a merging unit to embed the watermark in the personal information image.

2. The personal information providing apparatus of claim 1, wherein the predetermined standard includes at least one of a type and a level of access to the personal information.

3. The personal information providing apparatus of claim 1, further comprising:
a random code generation unit to generate at least one Pseudo Random Noise (PN) code,
wherein the merging unit embeds the at least one PN code in the personal information image.

4. The personal information providing apparatus of claim 1, further comprising:
a receiving unit to receive a personal information request from a personal information requesting terminal;
an analysis unit to analyze the personal information request and determine the predetermined standard; and
a transmission unit to transmit the personal information image to the personal information requesting terminal.

5. The personal information providing apparatus of claim 1, wherein the personal information extraction unit extracts the personal information about the at least one characteristic based on a level of access to personal information corresponding to the predetermined standard.

6. The personal information providing apparatus of claim 5, wherein the image generation unit applies an access control factor, determined based on the level of access to the personal information, to the personal information about the at least one characteristic to generate the personal information image.

7. The personal information providing apparatus of claim 4, wherein the trace information includes information about at least one of a generation time of the personal information image, a transmission time of the personal information image, and the personal information requesting terminal.

8. The personal information providing apparatus of claim 7, further comprising:
a watermark extraction unit to extract the watermark from the personal information image; and
a trace information extraction unit to extract the trace information from the watermark.

9. A personal information providing method, comprising:
extracting personal information about at least one characteristic corresponding to a predetermined standard from a database storing personal information of a plurality of characteristics;
embedding the personal information about the at least one characteristic in a predetermined image and generating a personal information image;
generating a watermark having trace information embedded configured to trace the generation of the personal information image; and
embedding the watermark in the personal information image.

10. The personal information providing method of claim 9, further comprising:
generating at least one Pseudo Random Noise (PN) code; and
embedding the at least one PN code in the personal information image.

11. The personal information providing method of claim 9, further comprising:
receiving a personal information request from a personal information requesting terminal;
analyzing the personal information request and determining the predetermined standard; and
transmitting the personal information image to the personal information requesting terminal.

12. The personal information providing method of claim 9, wherein extracting personal information includes extracting the personal information about the at least one characteristic based on a level of access to f personal information corresponding to the predetermined standard.

13. The personal information providing method of claim 12, wherein generating of the personal information image including applying an access control factor, determined based on the level of access to the personal information, to the personal information about the at least one characteristic to generate the personal information image.

14. The personal information providing method of claim 13, further comprising:
receiving the personal information image at a personal information requesting terminal;
generating a second personal information image by referring to a table of the personal information requesting terminal storing predetermined personal information; and
calculating a correlation between the personal information image and the second personal information image.

15. A computer-readable recording medium storing a program for implementing a personal information providing method including instructions to cause a processor to:
extract personal information about at least one characteristic corresponding to a predetermined standard from a database storing personal information of a plurality of characteristics;
embed the personal information about the at least one characteristic in a predetermined image and generating a personal information image;
generate a watermark having trace information embedded therein configured to trace generation of the personal information image; and
embed the watermark in the personal information image.

16. A personal information providing system, comprising:
a personal information requesting terminal to generate a personal information request;
a personal information providing apparatus including:
a receiving unit to receive the personal information request from the personal information requesting terminal
a database to store personal information of a plurality of characteristics;
a personal information extraction unit to extract personal information from the database regarding at least one characteristic corresponding to a predetermined standard;
an image generation unit to embed the extracted personal information about the at least one characteristic in a predetermined image and generate a personal information image;
a watermark generation unit to generate a watermark having trace information embedded, the trace information configured to trace generation of the personal information image;
a merging unit to embed the watermark in the personal information image; and
a transmission unit to transmit the personal information image to the personal information requesting terminal.

17. The personal information providing system of claim 16, wherein the personal information requesting terminal is configured to generate a second personal information image when the personal information image is received by referring to a table storing predetermined personal information, and to calculate a correlation between the personal information image and the second personal information image.

18. The personal information providing system of claim 16, wherein the personal information extraction unit extracts the personal information about the at least one characteristic based on a level of access to personal information corresponding to the predetermined standard.

19. The personal information providing system of claim 18, wherein the image generation unit applies an access control factor, determined based on the level of access to the personal information, to the personal information about the at least one characteristic to generate the personal information image.

20. The personal information providing system of claim 16, wherein the trace information includes information about at least one of a generation time of the personal information image, a transmission time of the personal information image, and the personal information requesting terminal.

21. The personal information providing system of claim 20, wherein the personal information providing apparatus further comprises:
a watermark extraction unit to extract the watermark from the personal information image; and
a trace information extraction unit to extract the trace information from the watermark.
